(19) United States
(12) Patent Application Publication
(10) Pub. No.: US 2016/0053922 A1
(43) Pub. Date: Feb. 25, 2016

(54) ENDLESS ON-SITE PIPE MANUFACTURING

(71) Applicant: Mohammad R. Ehsani, Tucson, AZ (US)

(72) Inventor: Mohammad R. Ehsani, Tucson, AZ (US)

(21) Appl. No.: 14/465,770

(22) Filed: Aug. 21, 2014

(51) Int. Cl. F16L 9/14; B29C 65/48; B29C 65/00; B29C 41/40; B29C 41/22

(52) U.S. Cl. CPC F16L 9/14; B29C 41/40; B29C 41/22; B29C 66/49; B29C 65/4835; B29K 2101/00

(57) ABSTRACT

Method and article of manufacture are disclosed for on-site manufacturing of any length, any shape, size, and any thickness pipe. Sheets of materials fulfilling the requirements of the inner surface of the pipe is first wrapped around a mandrel of a desired size and cross-section to form a pipe-liner. As described, the pipe-liner can also be manufactured by spraying fast-setting materials on the mandrel or injecting desired materials into a form surrounding the mandrel. Afterwards, fabrics saturated with resin are wrapped around the manufactured pipe-liner. Completed pipe section is partially pushed off the mandrel and another similar partial pipe is manufactured around the mandrel as a continuation of the previous partial pipe section. This process is repeated to manufacture a seamless pipe of any desired length. Disclosed pipes eliminate almost all weaknesses of plastic, metal, and concrete pipes and noticeably reduce costs of transportation and manufacturing.

### CROSS-REFERENCE(S) TO RELATED APPLICATION(S)

This Non-provisional patent application is related to U.S. Provisional patent applications No. 61/967,477, filed on Mar. 20, 2014, titled “Continuous HDPE-FRP Pipe & Equipment for Manufacturing of Pipe,” the disclosure of which is hereby expressly incorporated by reference in its entirety, and the benefit of the priority date of which is hereby claimed under 35 U.S.C. §119(e). This application is also related to the U.S. patent application Ser. No. 13/488,359, filed on Jun. 4, 2012, titled “Continuous Onsite-Manufactured Pipe”.

### TECHNICAL FIELD

This application relates generally to pipe manufacturing and repair. More specifically, this application relates to a method and apparatus for on-site manufacturing of pipes of any length and any size and shape.

### BACKGROUND

For centuries pipes have been used to carry fluids, gases, etc. in water, wastewater, gas, oil, mining and other industries. All these pipes, especially for large projects, are manufactured in factories in pieces that are typically 16-24 feet long and are shipped by trailers or trains to the jobsite for installation. During the installation process, the short pieces are joined together to create a longer pipe. In buried pipes, a trench must be excavated to place the pipe below ground.

There are several shortcomings with such a system. (1) The shipping is very costly as often these pipes are bulky and hollow; in fact the trucks carry a lot of “empty” and unused space enclosed within and between the hollow pipes. When larger diameter pipes (4-ft and larger) are transported, only a few pieces of pipe can be placed on a truck bed which adds tremendous expense to the project. (2) The pipe sections are very heavy and require heavy lifting equipment on-site to remove the pipe from the truck bed and position it in the trench. (3) The joints in all pipes are the major source of leakage; there are numerous organizations such as ASCE and EPA that provide statistics on the continuous waste of water, and leakage of pollutants such as sewer, gas, oil, etc., and waste of other resources because of leakage through the pipe joints while contaminating the surrounding areas. The joints are also a point where plant roots can penetrate sewer pipes, for example, causing clogging of such pipes. (4) When steel or concrete pipes are used, the steel in these pipes corrodes over time, causing failure of the pipes which in turn incur major repair or replacement costs. (5) In industries such as gas and oil, where steel pipes are frequently used, cathodic protection systems must be installed to protect these pipes against corrosion. These systems require continuous monitoring and replacement of components to ensure proper operation. These costs become significant over the life of the pipe. (6) The electrical current that passes through gas or oil pipes, for example, can become stray and accelerate corrosion of other nearby metallic structures. This, for example, is a concern of the electrical utilities where their steel poles corrode at a much faster rate due to these stray currents. Depending on the strength of the current, a pipe may adversely affect a utility pole that is hundred feet or more away from the pipe. The transportation, loading and unloading of heavy large pipes is a dangerous task. According to OSHA, there were 19 reported fatalities in 2013 (OSHA, 2013) and the Department of Labor shows 2 out of every 100 pipeline workers are non-fatally injured annually (Bureau of Labor Statistics, 2012).

The construction of currently used pipes that are made of steel, concrete or plastics (e.g. PVC, fiberglass, etc.) requires major manufacturing equipments that must be housed in a factory and which are not portable. For example, the equipments needed to melt the steel or roll a steel sheet into a cylindrical pipe is very bulky and heavy. Likewise, mixing of concrete and casting it in a mold to produce a concrete pipe is very difficult and does not lend itself to on-site manufacturing. Even in the case of fiberglass or other plastic pipes, their manufacturing requires a great deal of heat and spinning equipment (since many of these pipes are cast in centrifugal rotating machines), which require large spaces and facilities and are generally not portable to job sites. Therefore, such pipes can never be constructed on-site on an “as-needed” basis.

### BRIEF DESCRIPTION OF THE DRAWINGS

The drawings, when considered in connection with the following description, are presented for the purpose of facilitating an understanding of the subject matter sought to be protected.

FIGS. 1A, 1B, and 1C show examples of forming a pipe-lining/inner-pipe for an on-site pipe manufacturing;

FIGS. 2A, 2B, and 2C show examples of strengthening the pipe-lining of FIGS. 1A, 1B, and 1C by wrapping at least a layer of FRP (Fiber Reinforced Polymer) material around the pipe-lining to create a load-bearing pipe-cover;

FIG. 3 shows another example of on-site pipe manufacturing, where the pipe-lining is sprayed inside the pipe-cover after the pie-cover is formed by FRP wrapping; and

FIG. 4 shows an example process of on-site pipe manufacturing.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

Briefly described, methods and articles of manufacture are disclosed for replacing, repairing, reinforcing existing pipes, and on-site-manufacturing of new pipes of various shapes and sizes and lengths, with minimum cost, effort, and time. The disclosed methods and articles of manufacture basically include on-site forming of an “inner-pipe”/“pipe-liner” enclosed in a “pipe-cover”/“outer-shell”, wherein the pipe-liner fulfills inside-surface requirements of the pipe and the pipe-cover provides any additional strength required for the usage of the pipe. In some embodiments the pipe-cover provides all or most of the required structural strength of the pipe. These on-site-manufactured pipes can replace an entire pipe or a part or a segment of a pipe or repair a pipe or a structural member from outside, inside, or both. Aside from replacing an entire pipe or a part or a segment of a pipe, the on-site manufactured pipes may be used inside a damaged pipe or on the outside of a damaged pipe or both.

The on-site manufactured inner-pipe/pipe-liner is designed to satisfy the requirements of the inside of the finished pipe, such as chemical resistance, heat resistance, water-tightness, friction, etc., whereas the on-site formed pipe-cover is designed to strengthen the pipe to withstand various loads exerted from inside and/or outside of the pipe. In various embodiments the pipe-cover is formed by wrapping FRP (Fiber Reinforced Polymer) material around the inner-pipe/pipe-liner. This process, as described below, can also be employed to produce endless pipes at a job-site. In one example, the on-site manufacturing machines may be mounted on a mobile unit and while the mobile unit moves forward, manufactured pipe may be pushed out from the back end of the mobile unit.

US Patent Publication 2012/0222771 A1 attaches sections of already manufactured pipes together at the job-site and wraps a strip of material around the joined pipes. On the contrary as mentioned above, among other goals, the present disclosure aims to avoid transportation of the manufactured pipes to the job-site; rather, teaches on-site forming of the inner-pipes from sheets of materials, the transportation of which is highly efficient. For example, using the present methods, the same truck which can only transport forty 10″ diameter pipes at a time, can carry enough sheets in one trip to at least manufacture 300 pipe sections of the same length at the job-site.

U.S. Pat. Nos. 3,837,970 and 3,929,544, both by Medrano, teach manufacturing a pipe by merely wrapping reinforced plastic tapes over a mandrel; however, such pipe does not have a desired pipe-liner that can be designed to fulfill any requirement of the inner surface of a pipe. The user of Medrano's pipe is stuck with one inner surface for all his applications.

Pipe manufacturing and installation, and also pipe repair and replacement can be expensive, cumbersome, and time consuming. Pipes can get damaged due to a variety of factors, such as earthquakes, overloading, traffic weight, wear and tear, corrosion, explosions, and the like. If damage does occur to a pipe, a cost-effective and speedy method of repair is clearly desirable. While pipe repair and replacement are emphasized in this disclosure, other structures, damaged or undamaged, can benefit from the disclosed methods and apparatus. The disclosed on-site manufactured pipes can even be used as concrete molding, such as for bridge columns, and such forms can be left around the concrete structural elements for protection.

Since the disclosed methods allow on-site manufacturing of infinite length pipes, these methods may be used for laying down miles of pipes for various purposes, such as for gaseous or liquid fluid transportation. Another example of application is the use of long tubes as casing inside drilled shafts in the ground as a stay-in-place formwork to fill with grout or concrete. Another example is the use of the disclosed manufactured pipe in oil fields where the pipe can be continuously made and at the same time pushed into a subterranean oil well being drilled. Another example is the use of such a pipe as the recently announced Hyperloop by Tesla CEO Elon Musk. This long tube supported on columns connects Los Angeles to San Francisco and can be used for a high-speed train.

In various embodiments, the pipe-cover/outer-shell is constructed from fiber-reinforced material, such as Fiber Reinforced Polymer (FRP) to give the pipe more resistance against various types of inside and outside loading. Those skilled in the art will appreciate that many types of reinforcement fibers may be used for manufacturing the outer-shell of the disclosed pipes including polymer, fiberglass, metal, cotton, other natural fibers, and the like. The sheet materials used in manufacturing the pipe-liner of these pipes may include fabrics made with fibers such as glass, carbon, Kevlar, Nomex, aluminum, and the like; some saturated with a polymer such as polyester, vinyl ester, or epoxy for added strength, wear resistance, and resilience. The fibers within a reinforcement sheet may be aligned in one direction, in cross directions, randomly oriented, or in curved sections to provide various mechanical properties, such as tearing tendency and differential tensile strength along different directions, among others. Materials known as 3-D fabric manufactured by Jushi Beihai Fiberglass Co. in China can also be used. Other multi-dimensionally woven materials, known as multi-axial fabrics, can also be used in the manufacture of these pipes. Such materials are currently obtainable from companies such as Fiber Materials, Inc., 5 Morin Street, Biddeford, Me.

In this disclosure, the word “fiber” is used for any sheet of material the strength of which, at least partially and at least in one direction, depends on fibers of some kind, whether the fibers are woven, stitched, or held together by other means such as glue.

The outer-shell reinforcement layer(s) that form parts of the on-site manufactured pipes may be laminated in the field using epoxy, various glues, or similar adhesives to create a laminated composite that is stiffer than the sum of the individual reinforcement layers. Different reinforcement layers may use sheets with fibers oriented in different directions, such as orthogonal directions, with respect to other sheets to further reinforce the laminated composite. A laminated composite can be designed to endure different forces in different directions. In embodiments with multi outer-shell reinforcement layers, one or more of the layers may not be fibrous layers.

Similarly, the inner-pipe/pipe-liner may be manufactured using sheets of plastic, FRP, metal, vinylester, HDPE, PVC, PET, PETE, etc. Those skilled in the art will recognize that many other types of inner-pipe material such as honeycomb, hollow structures, or laminated structures are possible without departing from the spirit of the present disclosures. The inner-pipe, as will be discussed below, may even be manufactured by spraying certain fast-setting chemical compounds over different shape and size mandrels. The inner-pipe can provide, for example, abrasion and chemical resistance when the pipe is carrying chemicals and slurry-type materials that could result in excessive wear on the surface of the pipe. The inner-pipe/pipe-liner layer can also be impervious and water-tight and be designed to resist some of the internal pressure of the pipe.

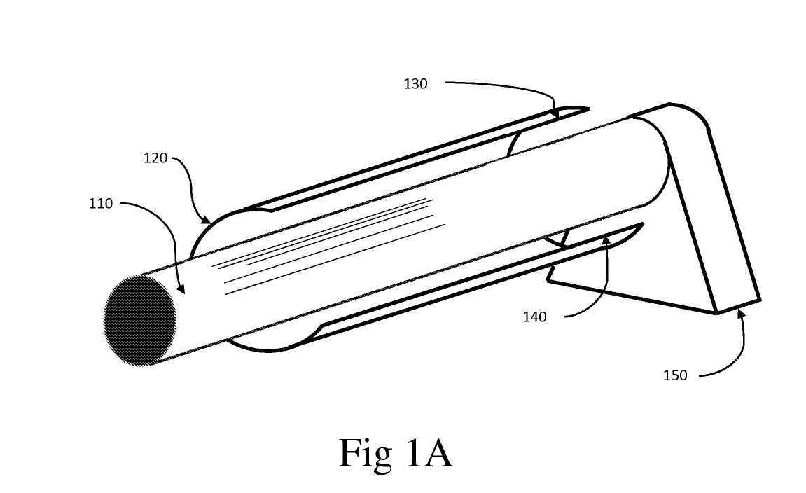

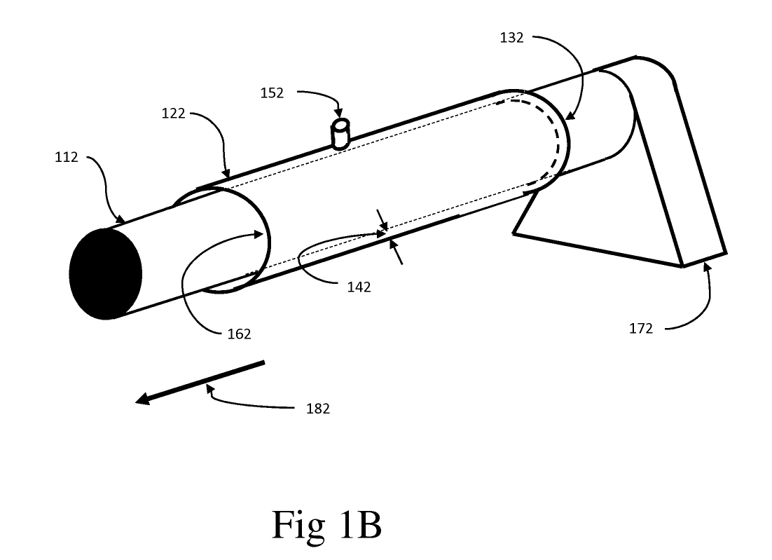

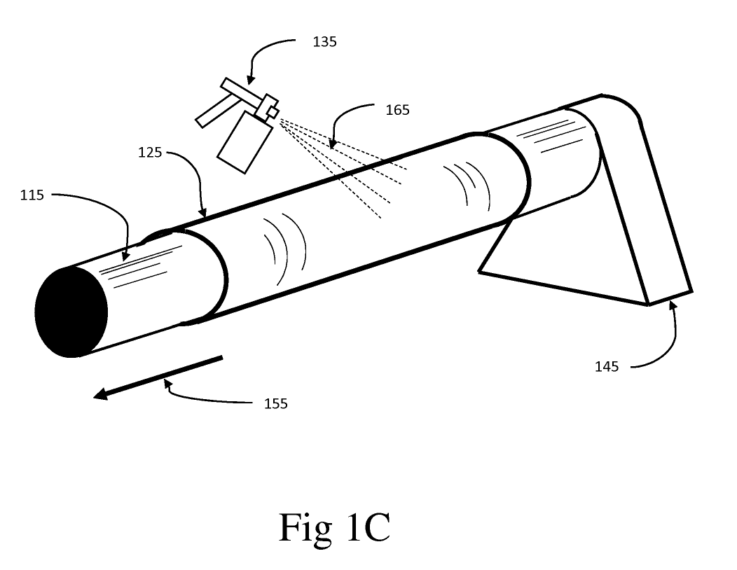

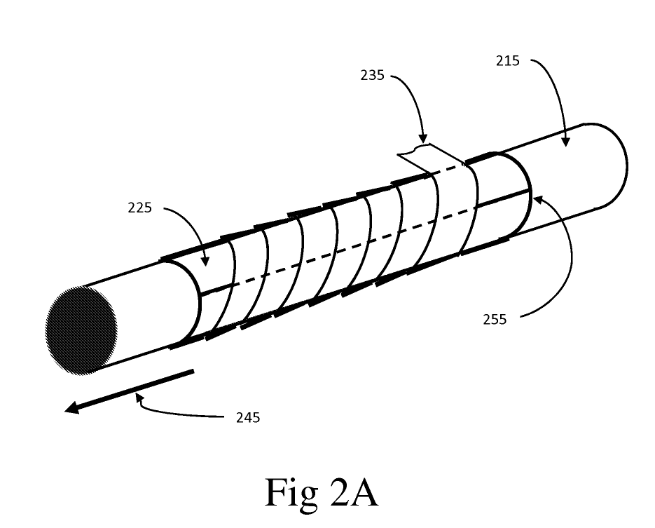

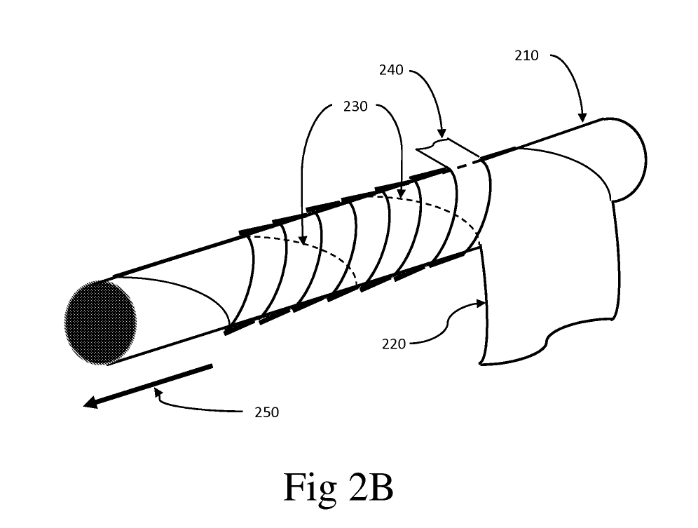

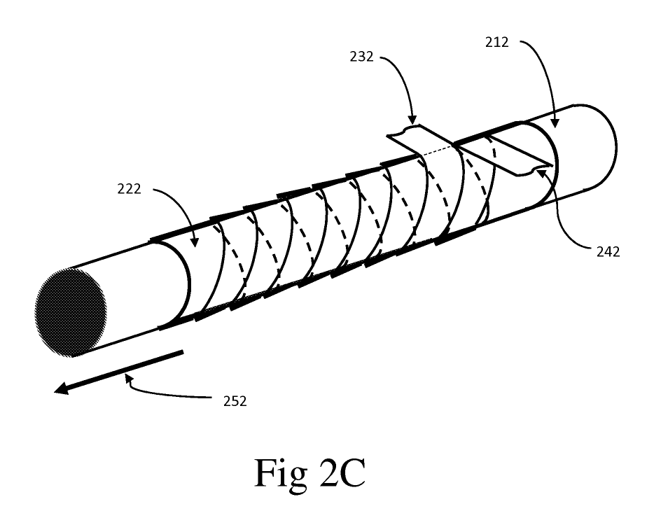

Example materials for building outer-shells are “FRP” and resin,” which are very light-weight and can be delivered to the job site or even stored on a mobile platform such as a trailer or a truck that can move along the trench where the pipe is being made or repaired. The following is an example method of manufacturing a pipe on-site, the different phases of which are depicted in FIGS. 1A, 1B, 1C, 2A, 2B, and 2C. Some of the disclosed steps may be totally eliminated or reordered as desired.

1. As shown in FIGS. 1A, 1B, and 1C a mold or a mandrel 110, 112, or 115, respectively, is provided that represents the desired size and shape of the pipe being manufactured. For example, an already available metal pipe may be used as mandrel. This mandrel can also be designed to be “collapsible,” so once the pipe is constructed the mandrel is collapsed to a smaller size to allow effortless removal of the finished pipe and easy transportation of the mandrel. Those skilled in the art will realize that the cross-section of the mandrels and manufactured pipes need not be circular and can have any desired geometric shape, such as oval, square or polygon.

2. A release agent, for example, may be optionally applied to the mandrel 110, 112, or 115, or a plastic/nylon sheet may be wrapped around these mandrels, to allow easy removal of the finished pipe from the mandrels.

3. In various embodiments, the inner-pipe may be manufactured differently. For example in FIG. 1A, one or more sheets of appropriate/desired/required material 120 is wrapped around mandrel 110. In this embodiment, the edges 130 and 140 may be either overlapped or be placed abutted. Furthermore, these edges may be permanently connected by glue, resin, welding, fusion bonding or any other means. The inner-pipe sheet 120 may even be optionally wrapped around itself one or more times. An optional layer of epoxy may be also applied to the outer surface of the inner-pipe layer.

In another embodiment shown in FIG. 1B, a mold 122 may be situated around mandrel 112 into which an appropriate pipe-liner material is injected from opening 152, which forms an inner-pipe in the space between mold 122 and mandrel 112. As shown in FIG. 1B, the end 132 of mold 122 is closed and the end 162 of mold 122 is open so that the formed inner-pipe can be pulled out of the space between mold 122 and mandrel 112, in the direction 182, and that a new part be molded and added to it. In this embodiment mandrel 112 is attached from one side to support/stand/base/platform 172 in a cantilever position. The free end of the cantilevered mandrel may be supported, for example, over some rollers such that the formed sheets can be moved off the mandrel from in between the mandrel and the roller(s).

In yet another embodiment shown in FIG. 1C, to form the inner-pipe layer 125, a fast-setting substance 165 may be sprayed over mandrel 115 by sprayer 135. In some embodiments the sprayed material may be non-sticking. A long inner-pipe layer may be produced by partially moving the sprayed-and-set layer 125 in the direction 155 and spraying another layer 125 over the mandrel 115 such that the new sprayed section becomes the continuation of the previous inner-pipe section. In FIG. 1C mandrel 115 is also shown to be attached from one side to stand 145 in a cantilever position. The sprayable coating products may be various chemicals and polymers such as polyurea, epoxies, polyurethane, etc. An example of these products is “PipeArmor” by Quest Inspar, LLC, 410 Pierce Street Houston, Tex. 77002, USA.

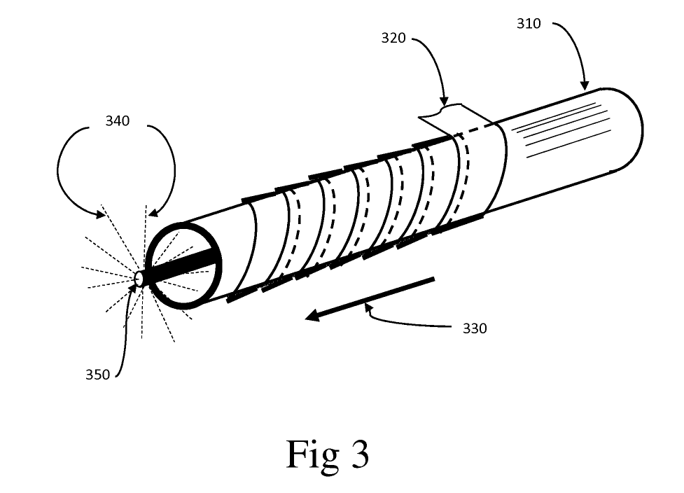

4. After formation of an inner-pipe section over a mandrel, one or more layers of resin or glue saturated FRP, or similar material, is wrapped around the formed inner-pipe section to create an outer-shell for the pipe. As will be discussed with respect to FIG. 3, in some embodiments the pipe-cover may be formed first and the inner-pipe liner may be sprayed over its inside surface afterwards. The following three examples describe the process of FRP wrapping.

In one embodiment, as shown in FIG. 2A, one layer of FRP material 235 is helically and overlappingly wrapped around inner-pipe 225 which itself has been formed around mandrel 215 as previously described with respect to FIG. 1A. In various embodiments more than one layer of materials may be wrapped around inner-pipe 225, in the same or different directions. At this point the formed pipe section may be moved partially off the mandrel 215, in the direction 245, and a new inner-pipe will be formed over the mandrel 215 that is attached to the previously formed inner-pipe 225 at end 255. The wrapping of material 235 will also be continued over the newly formed inner-pipe section. This process may continue until a seamless pipe of desired length is manufactured.

The embodiment shown in FIG. 2B is similar to the one shown in FIG. 2A; however, the inner-pipe material 220 is also helically wrapped around mandrel 210. In this embodiment, similar to wrapping of the FRP material 240, the inner-pipe material 220 can also be wrapped indefinitely and continuously around mandrel 210 as the formed pipe sections move off the mandrel 210 in the direction 250. The edges 230 of the wrapped inner-pipe material 220 may be either butt-joined or overlapped. In FIG. 2B the support for mandrel 210 is not shown.

FIG. 2C shows two wrappings 232 and 242 over the sprayed inner-pipe layer 222. In this embodiment, the two wrappings 232 and 242 have been wrapped in opposite directions. Here again, the formed pipe section may be partially pushed/slid off the mandrel 212 in direction 252 and the spraying of the inner-pipe layer and the wrapping of the layers may be continued until a complete seamless pipe with desired length is manufactured.

In an embodiment shown in FIG. 3, the outer-layer of the pipe may be formed before its inner-layer. In this embodiment the FRP material 320, and additional optional layers, is continuously wrapped around mandrel 310 and the wrapped outer-layer is continuously pushed off mandrel 310 in direction 330 and as the wrapped outer-layer exits the mandrel 310, sprayer 350 sprays a coat of inner-pipe material 340 over the inner surface of the outer-layer and forms a desired inner-pipe layer. It is obvious to those skilled in the art that the sprayer does not need to be placed at the end of the mandrel 310 and may even be positioned anywhere along the length of mandrel 310. In FIG. 3 the support/stand for mandrel 310 is not shown.

In summary, an inner-pipe and an outer wrapping is formed over a mandrel in sections, and is partially pushed off the mandrel to free-up a part of the mandrel to be able to add a new pipe section to the previously formed pipe section. As an optional step in various embodiments, the pipe sections may be cured by heat from inside or outside the mandrel. Also, in various embodiments the mandrel may or may not rotate around its longitudinal axis.

Those skilled in the art will recognize that inner-pipe and/or outer-pipe layers may or may not be helically wrapped and that the inner-pipe and/or outer-pipe sections may be added to each other in a butt-joined or an overlapping manner. (In some embodiments, an overlapping joint in the direction of the flow may be desirable to provide a “shingle” effect for the fluids to flow over the inner-pipe layer.) Those skilled in the art will also recognize that the inner-pipe and/or outer-pipe layers may be wrapped in the same or opposite directions. It is also important to note that it is not required for an outer-pipe layer to stick to the inner-pipe layer. Even if the outer-pipe layer slides over the inner-pipe layer, it will not compromise the load capacity of the manufactured pipe. In various embodiments the outer-pipe fabric material used for wrapping over the inner-pipe may be continuous and cover many inner-pipe segments or may be discontinuous and merely start by overlapping the previous wrapping of a previous pipe segment.

In cases where the manufactured pipe is being inserted into a damaged host pipe to replace the function of a part of the damaged pipe, at least a part of the outside surface of the manufactured pipe such as its ends may be roughed, for example by sanding or by sand blasting or by spraying a mixture of sand and resin, to enhance bonding of the pipe to the host pipe in the field.

Mandrels can be mounted on a moving station, such as a truck-bed, that can travel alongside a pipe trench. Such procedure allows the light-weight constituent materials of the pipe, namely the inner-pipe sheets, FRP, resin and the materials for the optional layers to be delivered to the crew while the pipe is constructed and placed. If desired, the raw materials can be placed on the same moving platform as the mandrels, or on a separate moving platform adjacent to the mandrels platform, for higher productivity.

According to the described embodiments, it is possible to build pipes of unlimited lengths without any joints. However, periodically along the length of the pipe, joints may be necessary based on other considerations. Pipe joints of different kinds are well known in the industry.

Another advantage of the disclosed pipe is that it can be easily cut and spliced in the field. Splicing of the pipe will later require joints to connect the splice, where the above-mentioned joining systems can be used. Moreover, externally wrapped FRP bands can also provide a leak-proof and strong joint. Alternatively, a larger size pipe of similar construction disclosed here can be built and cut into 1-ft long (shorter or longer) slices; these slices can serve as coupling sleeves that would slip over the ends of adjoining pipes (about 6 inches on each pipe); the small annular space between the original pipe and the coupling sleeve can be sealed with a rubber gasket or a hydrophilic seal that would expand after exposure to water to create a compression seal between the coupling sleeve and the pipe. If the pipe diameter is large enough to allow man entry, the joint can be made internally with FRP, or clamps such as Weko Seal and/or other similar products that are readily available.

The disclosed pipes are flexible enough to accommodate small radii of curvature as most pipes do. However, if an abrupt change of angle is needed, it may require a special mandrel for constructing a pipe with a particular shape or angle. Alternatively, a joint may be introduced at such locations and an especially-made curved pipe, elbow or fitting can be used to complete the change of direction of the pipe.

The materials including resins used in the construction of the disclosed pipes may be selected from a family of environmentally safe products so that the finished pipe is safe for potable water. QuakeWrap, Inc. (Tucson, Ariz.), for example, provides such fibers and resins that meet the NSF-61 industry standards for potable water.

The disclosed pipes are extremely light and very strong. For example, these pipes weigh approximately 1 pound per square foot compared to a fiberglass pipe manufactured by Hobas Pipe USA (Houston, Tex.) that weighs over 16 pounds per square foot. All components of the pipe (for example, FRP, resin, and inner-pipe) work together to provide the stiffness and resistance to external loads (e.g. soil, traffic, impact, blast, etc.). A typical FRP layer is less than 0.05 inch thick; therefore, one may significantly increase the internal pressure rating of a pipe by adding one or more layers of FRP to the surface of the pipe, which will only cause a tiny increase in the pipe wall thickness and the weight of the pipe while increasing the pipe strength significantly.

It must be noted that in various embodiments the resin or any other adhesives used in the disclosed processes may be heat-cured by different methods, for example using gas, electricity, light, and/or microwave. In various embodiments, the heating of the resin can be achieved using microwave technology. The microwaves can be pointed from outside of the pipe or mandrel towards the exterior surface of the pipe. These can be in the form of a tunnel or tube surrounding the mandrel and the pipe being manufactured. Recently developed Variable Frequency Microwave (VFM) by Lambda Technologies are also a more efficient way of heat curing the resin with minimum energy consumption and a higher quality cured composite. In recent years VFM heating apparatus have been developed (Bible, et al. U.S. Pat. No. 5,961,871). These devices have the advantage that provide a more efficient uniform heating of the subject, unlike conventional home/kitchen microwaves that operate at a fixed frequency and leave parts of the subject unheated.

In some embodiments, the microwave oven can be constructed in the form of a tunnel that encompasses the mandrels. The conventional microwave or VFM oven is turned on, for example, for a minute or two to cure the resin saturated FRP pipe. If necessary, another conventional microwave oven or a VFM oven is placed inside the mandrel or near the free end of the mandrel so the pipe can be cured from inside while on the mandrel or shortly after it leaves the mandrel. Thus the pipe may be cured from both inside and outside.

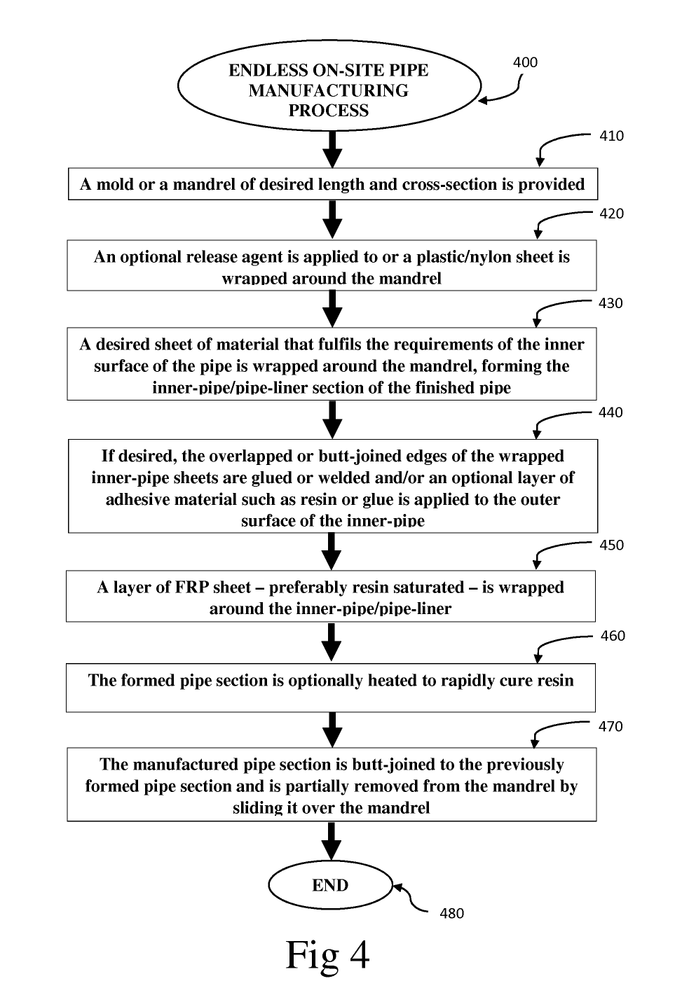

FIG. 4 shows an example process of manufacturing a pipe using an inner-layer and a resin saturated outer-layer. Process 400 proceeds to block 410 where a mold or a mandrel of desired length and cross-section is provided. Readily available products, such as pipes, whose outside dimensions fulfill the user's requirements, can be adopted to operate as a mandrel. As a further example, sheet metal can also be wrapped around a frame to create a mandrel of any desired shape, e.g. oval, arch, etc. The outer surface of this mandrel can be made of or coated with Teflon or similar non-sticky product. The process proceeds to block 420. At block 420, a release agent is optionally applied to or a plastic/nylon sheet is wrapped around the mandrel, or any other means, to allow easy removal of the finished pipe from the mandrel. The process proceeds to block 430. At block 430, wrap any desired sheet of material or spray any desired chemical compound, which fulfils the requirements of the inner surface of the pipe, over the mandrel. This layer will form the inner-pipe/pipe-liner section of the finished pipe. These sheets may be separate rectangular sheets, each of which can form a section of the inner-pipe or may be a continuous band which is wound helically around the mandrel. At block 440, if desired, glue or weld the overlapped or butt-joined edges of the wrapped inner-pipe sheets and, if desired, apply an optional layer of adhesive material such as resin or glue to the outer surface of the inner-pipe. The process proceeds to block 450. At block 450, wrap one or more layers of FRP or other sheets around the inner-pipe of block 430. The FRP may be resin saturated and may be wound helically around the inner-pipe. The FRP or other layers of this step may also include spacer sheets such as 3D or multi-axial fabric or honeycomb and the like. More than one FRP layer may also be wound around the inner-pipe in same or opposite directions. The process proceeds to block 460. At block 460, to rapidly cure the resin, optionally heat the formed pipe section. The process proceeds to block 470. At block 470, add the formed pipe section to the previously formed pipe section and partially remove the manufactured pipe section from the mandrel by sliding it over the mandrel. The process proceeds to block 480, at which step the process ends or may go back to 430 to add to the length of the manufactured pipe.

The above manufacturing process lends itself well to automation. As another embodiment, a mobile platform can be constructed that will house the raw materials (e.g., resin, FRP, inner-pipe sheets), the mandrel, and the fabrication machinery. The equipment can include moving arms that will pick up the raw materials and apply them around the mandrel and cure the resin. Certain changes in the procedure simplify the process for the robot without adversely affecting the quality of the finished pipe. For example, it may be easier for a robot to apply a film of resin (like a paint spray), apply the dry FRP fabric and spray more Resin on top of the dry fabric to saturate it. Robots can significantly increase quality of the finished product and the production rate. At the same time the cost of a pipe manufactured with such robots can be much lower than a hand-made pipe. In some embodiments a combination of man and robots may be employed to manufacture the disclosed pipes. For example, a worker may provide and wrap the inner-pipe sheets around the mandrel while a robot applies the Resin and the FRP layers.

The same basic disclosed method of pipe-making-around-a-mandrel may be used to form a new pipe around an existing pipe for the purposes such as leakage. For example, the steel pipes carrying toxic material start leaking over time and start contaminating the ground and the water. In such cases a tight or a loosely fitting outer pipe may be manufactured, on-site, around these steel pipes which will completely contain any leakage for many years to come. These enclosure pipes can also be designed to stand the fluid or gas pressures within the steel pipe any time the pressure between the steel pipe and the enclosure pipe becomes equal.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of manufacturing a pipe of any length and any cross-section, the method comprising:
forming at least one inner-layer around a mandrel, using sheets of desired material or using sprayed chemical compounds;
wrapping a desired number of resin-saturated fabric layers over the formed inner-layer, to complete a pipe segment;
partially removing the completed pipe segment from the mandrel;
adding, over the mandrel, a similarly formed inner-layer to the inner-layer of the partially removed pipe segment;
wrapping a desired number of resin-saturated fabric layers over the similarly formed inner-layer on the mandrel, to complete a new pipe segment; and
wherein curing of the resin-saturated fabric layers may be optionally accelerated.

2. The method of claim 1, wherein the mandrel is cantilevered and/or collapsible.

3. The method of claim 1, wherein the inner-layer is made of plastic, FRP, metal, vinylester, HDPE, PVC, PET, PETE, polymers, polyurea, epoxies, or polyurethane and/or the fabric layer is made of FRP.

4. The method of claim 1, wherein the resin is applied to the fabric before and/or after the fabric is wound.

5. The method of claim 1, wherein the acceleration of the curing is by convective, conductive, or radiative heat.

6. The method of claim 1, wherein the fabric is a fiber-reinforced material.

7. The method of claim 1, wherein the fabric layers are wound helically in same or opposite directions.

8. The method of claim 1, wherein the method is at least partially performed by a robot.

9. A method of manufacturing a pipe of any length, the method comprising:
Wrapping, continuously, a desired number of resin-saturated fabric layers over a mandrel, to form a tube;
moving, continuously or intermittently, the formed tube off the mandrel; and
spraying the inner surface of the tube with a desired inner-liner; and
wherein curing of the resin-saturated fabric layers may be optionally accelerated.

10. The method of claim 9, wherein more than one fabric layers are wound helically in opposite directions.

11. The method of claim 9, wherein the fabric is a fiber-reinforced material.

12. The method of claim 9, wherein the Resin is applied to the fabric before and/or after the fabric is wound.

13. The method of claim 9, wherein the inner-liner is made of polymers, polyurea, epoxies, or polyurethane and/or the fabric layer is made of FRP.

14. The method of claim 9, wherein the accelerated curing is by convective, conductive, or radiative heat.

15. The method of claim 9, wherein the mandrel is cantilevered and/or collapsible.

16. The method of claim 9, wherein the method is at least partially automated.

17. A pipe comprising:
a first pipe segment that includes a first outer-layer and a first inner-layer, wherein the first outer-layer is formed by wrapping a layer of glue- or resin-saturated fabric around a mandrel of desired shape and size and wherein the first inner-layer is formed by wrapping a sheet of desired material or spraying a desired chemical compound over the mandrel before the first outer-layer is formed or by spraying a desired chemical compound inside the first outer-layer after the first outer-layer is formed;
a second pipe segment that includes a second outer-layer and a second inner-layer, wherein the second outer-layer is formed by wrapping a layer of glue- or resin-saturated fabric around the mandrel and wherein the second inner-layer is formed by wrapping a sheet of desired material or spraying a desired chemical compound over the mandrel before the second outer-layer is formed or by spraying a desired chemical compound inside the second outer-layer after the second outer-layer is formed; and
wherein the first pipe segment and the second pipe segment have been connected over the mandrel.

18. The method of claim 17, wherein the first pipe segment is partially moved off the mandrel before the second pipe segment is formed.

19. The method of claim 17, wherein the mandrel is cantilevered.

20. The method of claim 17, wherein the pipe segments are optionally cured, at least partially, over the mandrel.
